(19) United States
(12) Patent Application Publication
(10) Pub. No.: US 2007/0019038 A1
(43) Pub. Date: Jan. 25, 2007

(54) Array inkjet head and inkjet image forming apparatus including the same

(75) Inventors: Young-su Lee, Yongin-si (KR); Jae-cheol Lee, Hwaseong-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/476,881

(22) Filed: Jun. 29, 2006

(30) Foreign Application Priority Data
Jul. 20, 2005 (KR) 2005-65702

(51) Int. Cl. B41J 2/05

(52) U.S. Cl. 347/63

(57) ABSTRACT

An array inkjet head and an inkjet image forming apparatus including the same. The array inkjet head includes a nozzle unit having a length that corresponds to a width of a printing medium, a plurality of printheads mounted in respective mounting grooves formed in the nozzle unit, and a plurality of heat absorbing units respectively formed in the mounting grooves to directly contact the respective printheads and absorb heat generated by the printheads.

### CROSS-REFERENCE TO RELATED APPLICATIONS

This application claims priority from Korean Patent Application No. 10-2005-0065702, filed on Jul. 20, 2005, in the Korean Intellectual Property Office, the disclosure of which is incorporated herein in its entirety by reference.

### BACKGROUND OF THE INVENTION

1. Field of the Invention

The present general inventive concept relates to an inkjet image forming apparatus, and more particularly, to an inkjet image forming apparatus including a heat absorbing unit that absorbs heat radiated from a printhead.

2. Description of the Related Art

Generally, an inkjet image forming apparatus forms an image on a printing medium by ejecting ink from an inkjet printhead disposed a predetermined distance away from the printing medium. A shuttle type inkjet printhead ejects ink onto the printing medium while being moved along a width direction of the printing medium, which is perpendicular to a feeding direction of the printing medium. The shuttle type inkjet printhead has been widely used for an image forming apparatus, however recently, a line type inkjet printhead having a nozzle unit with a length that is equal to a width of the printing medium has been increasingly used to perform high-speed printing.

FIG. 1 is an exploded perspective view illustrating a conventional shuttle type inkjet image forming apparatus, and FIG. 2 is a perspective view illustrating the conventional shuttle type inkjet image forming apparatus of FIG. 1.

Referring to FIGS. 1 and 2, a mounting groove 7 is formed on a bottom surface of a carriage 6 that moves along a widthwise direction of a printing medium. A plate 2 is mounted in the mounting groove 7. An ink path (not shown) through which ink flows and a printhead mounting groove 3 on which a printhead 1 is mounted are formed in the plate 2.

A printed circuit board 5 is mounted on a top surface of the plate 2 to enclose the printhead 1.

Although not shown, the printhead 1 includes a heating unit that generates heat to generate bubbles for ejecting ink, and thus the heat is radiated from the heating unit each time when the bubbles are generated. If the heat generated by the heating unit is not dissipated and continuously accumulates in the printhead 1, boiled bubbles may be generated and image quality may noticeably deteriorate.

In an effort to prevent the above problems, the plate 2 is made of ceramic with a heat conductivity higher than that of plastic so that the heat generated by the printhead 1 is naturally dissipated to the outside through the ceramic plate 2.

However, in order to mount the printhead 1 on the printhead mounting groove 3, the printhead mounting groove 3 is covered with a sealant 4 that is adhesive, and the printhead 1 is installed on the sealant 4.

The sealant 4, which is a high polymer adhesive and has less than 1% of the heat conductivity of metal, is less effective in heat transport and heat dissipation compared to ceramic. Consequently, the heat generated by the printhead 1 is not effectively dissipated, and the image quality deteriorates.

### SUMMARY OF THE INVENTION

The present general inventive concept provides an inkjet image forming apparatus capable of preventing heat from being accumulated in a printhead by absorbing the heat generated from the printhead, thereby maintaining a constant temperature of the printhead.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing an array inkjet head including a nozzle unit having a length that corresponds to a width of printing medium, a plurality of printheads mounted in respective mounting grooves formed in the nozzle unit, and a plurality of heat absorbing units respectively formed in the mounting grooves to directly contact the respective printheads and absorb heat generated by the printheads.

The foregoing and/or other aspects of the present general inventive concept are also achieved by providing an inkjet head, including a nozzle unit having at least one mounting portion disposed on a first surface thereof, and a heat absorbing unit disposed on a second surface of the nozzle unit opposite to the first surface and having an absorbing portion extending through the nozzle unit to the mounting portion thereof.

The foregoing and/or other aspects of the present general inventive concept are also achieved by providing an array inkjet head, including a nozzle unit having a mounting portion, a printhead mounted on the mounting portion, an adhesive layer disposed on the mounting portion between the nozzle unit and the printhead to adhere the printhead to the nozzle unit, and a heat transfer unit extending through the adhesive layer between the nozzle unit and the printhead.

The foregoing and/or other aspects of the present general inventive concept are also achieved by providing a nozzle unit usable in an inkjet image forming apparatus, the nozzle unit including a substrate having a plurality of openings extending therethrough, a printhead disposed on the openings in the substrate and being attached by an adhesive, and a heat absorbing unit disposed on the substrate to contact the printhead at portions around the openings in the substrate where the adhesive is not disposed and to transfer heat away from the printhead when the heat is generated.

The foregoing and/or other aspects of the present general inventive concept are also achieved by providing an array type inkjet head having a plurality of printheads, the array type inkjet head including a substrate, and a heat absorbing unit having a base disposed on a surface of the substrate and having a quadrangular frame shape with an opening disposed therein and extending along a plane, and a plurality of heat absorbing portions extending from the base in a direction that is perpendicular to the plane to contact one of the printheads and to transfer heat from the one of the printheads to the base.

The foregoing and/or other aspects of the present general inventive concept are also achieved by providing an array inkjet head, including a nozzle unit, and a printhead disposed on a first side of the nozzle unit to form an interface therewith. The interface includes an adhesive portion to adhere the printhead to the nozzle unit, a heat transfer portion having a heat transferring unit to transfer heat produced by the printhead to a second side of the nozzle unit opposite from the first side, and an opening portion through which ink is provided from the second side of the nozzle unit to the printhead at the first side of the nozzle unit.

The foregoing and/or other aspects of the present general inventive concept are also achieved by providing a heat absorbing unit usable with a nozzle unit having a plurality of printheads disposed on a first surface thereof and a plurality of througholes arranged on a second surface thereof to extend to the printheads, the heat absorbing unit including an array of frames being made of a heat conducting material, and at least one heat absorbing portion protruding from each of the frames in a perpendicular manner such that each of the absorbing portions is coupled to one of the printheads through one of the througholes from the second surface to the first surface.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is an exploded perspective view illustrating a conventional shuttle type inkjet printhead;

FIG. 2 is a perspective view illustrating the shuttle type inkjet printhead of FIG. 1;

FIG. 3 is a schematic view illustrating an inkjet image forming apparatus including an array inkjet head according to an embodiment of the present general inventive concept;

FIG. 4 is an exploded perspective view illustrating a nozzle unit of the array inkjet head of FIG. 3, according to an embodiment of the present general inventive concept;

FIG. 5 is a partially enlarged view illustrating a part of the nozzle unit of FIG. 4;

FIG. 6 is a cross-sectional view illustrating a portion of the nozzle unit taken along line V-V′ of FIG. 5;

FIG. 7 is a bottom view illustrating a bottom surface of the nozzle unit of FIG. 4;

FIG. 8 is a partially enlarged view illustrating a part of the bottom surface of the nozzle unit of FIG. 7;

FIG. 9 is a perspective view illustrating a heat absorbing unit of the nozzle unit of FIG. 4, according to an embodiment of the present general inventive concept; and

FIG. 10 is a perspective view illustrating a heat absorbing unit of the nozzle unit of FIG. 4, according to another embodiment of the present general inventive concept.

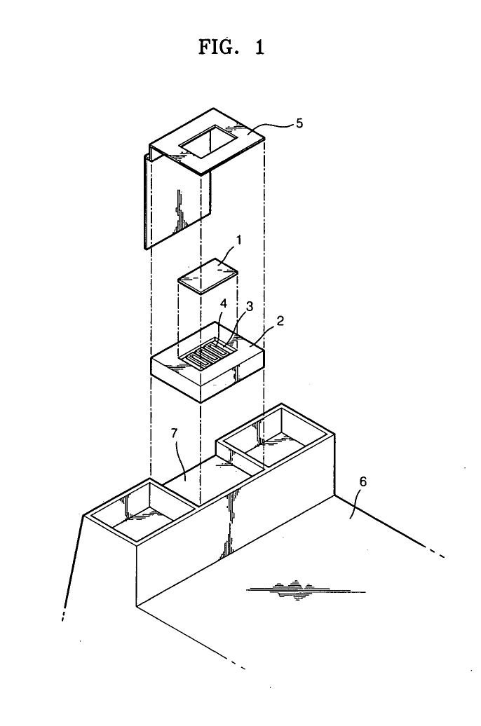

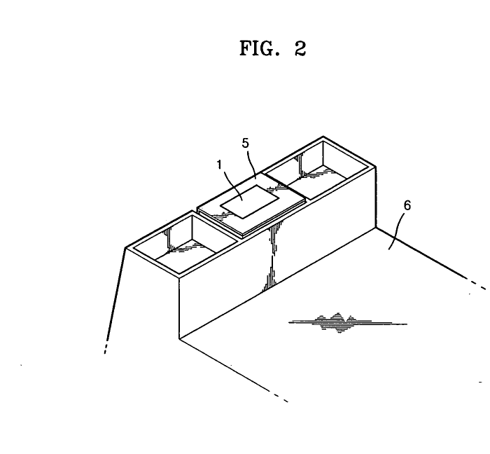

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

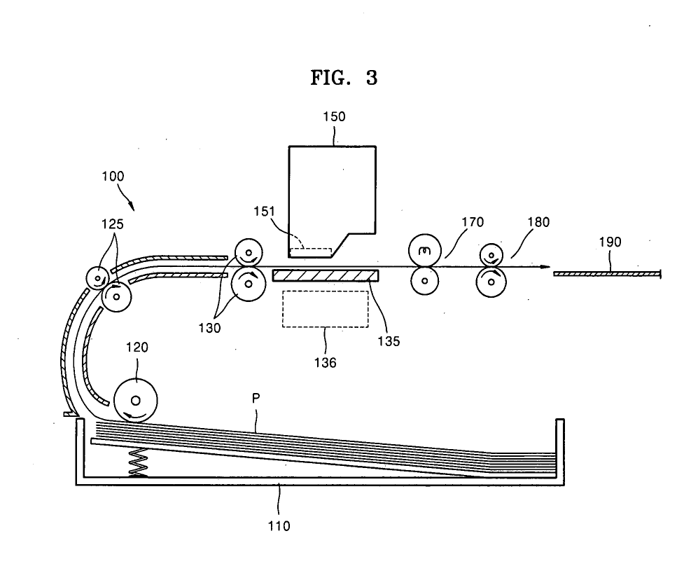

FIG. 3 is a schematic view illustrating an inkjet image forming apparatus 100 including an array inkjet head according to an embodiment of the present general inventive concept. Referring to FIG. 3, the inkjet image forming apparatus 100 includes a printing medium feeding cassette 110 that contains printing media P, a pick-up roller 120 that picks up the printing medium P from the printing medium feeding cassette 110, conveying rollers 125 that convey the picked up printing medium P, an array inkjet head 150 that forms an image on the printing medium P by ejecting ink onto the printing medium P, a drying device 170 that dries the printing medium P on which the image has been formed, and a discharger 180 that discharges the printed printing medium P from the image forming apparatus 100.

The pick-up roller 120 picks up the printing media P stacked in the printing medium feeding cassette 110, sheet by sheet.

The conveying rollers 125 convey the printing medium P picked up by the pick-up roller 120 such that the printing medium P passes below the array inkjet head 150. The conveying rollers 125 contact each other with a predetermined pressure, and the printing medium P may be transferred between the conveying rollers 125. Registration rollers 130 align the printing medium P such that the image is formed on a desired portion of the printing medium P.

A platen 135 is installed between the registration rollers 130 and the drying device 170. The platen 135 supports a rear surface of the printing medium P while the printing medium P is passing below the array inkjet head 150. The array inkjet head 150 is positioned above the platen 135 to form the image on the printing medium P by ejecting ink onto the printing medium. P.

The array inkjet head 150 is a line type inkjet printhead which enables high-speed printing. The line type inkjet printhead 150 is securely disposed along a width direction of the printing medium P that is perpendicular to a transferring direction of the printing medium P. The array inkjet head 150 includes a nozzle unit 151 that has a length that corresponds to a width of the printing medium P The nozzle unit 151 is disposed a predetermined distance above a top surface of the printing medium P. A space between the nozzle unit 151 and the printing medium P is called a “head gap.”

The array inkjet head 150 performs a capping operation by covering the nozzle unit 151 to prevent the ink contained in the array inkjet head 150 from drying, a wiping operation by wiping ink remaining on the nozzle unit 151, and a spitting operation by discharging the remaining ink into a maintenance region 136 to prevent the nozzle unit 151 from being clogged with the ink.

The drying unit 170, which dries the image formed on the printing medium P, may not have enough time to dry the ink ejected by the array inkjet head 150 that prints on a large area of the printing medium P for a predetermined period of time at a high speed. When sheets of the printing media P having ink that is not sufficiently dry are successively discharged to a discharging tray 190, the printing medium P on which the ink is not sufficiently dry may be stacked on a previously discharged printing medium P. Consequently, the ink on the previously discharged printing medium P, which is not sufficiently dry, stains the rear surface of the printing medium P stacked on the previous printing medium, thereby causing a smearing effect. This can cause an image quality to deteriorate.

The discharger 180 discharges the printing medium P, on which the image has been formed, to the discharging tray 190, and includes two rollers that discharge the printing medium P while being rotated.

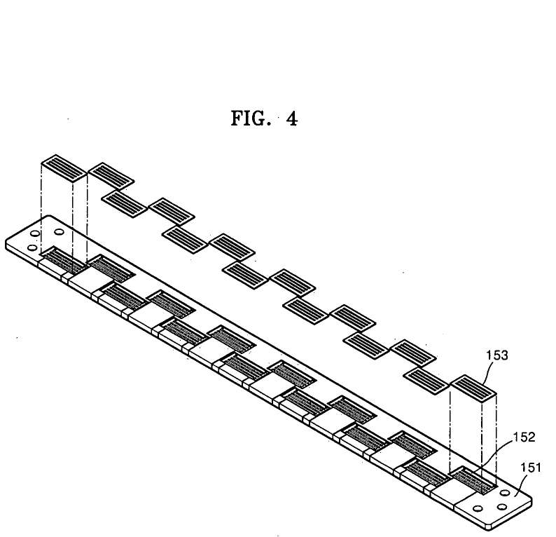

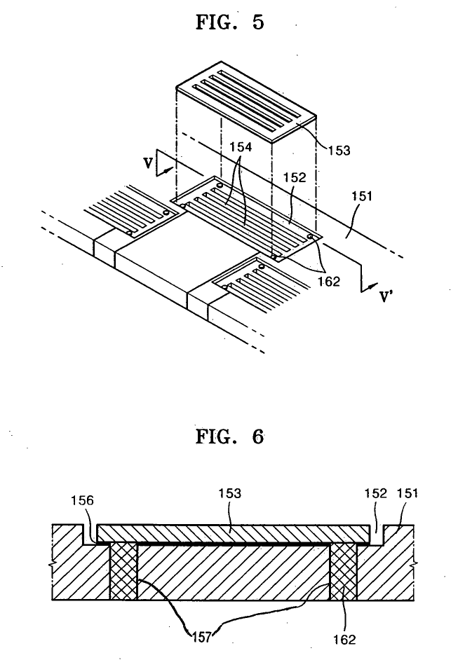

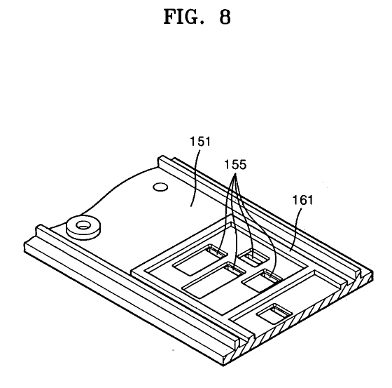

FIGS. 4 through 8 are views illustrating the nozzle unit 151. Referring to FIGS. 4 through 8, a plurality of mounting grooves 152 on which a plurality of printheads 153 are mounted are formed on the nozzle unit 151 along a length direction of the nozzle unit 151 (i.e., the width direction of the printing medium P). The nozzle unit 151 may be formed in a substrate. The mounting grooves 152 may be mounting portions.

Each of the plurality of mounting grooves 152 includes a plurality of ink channels 154 and througholes 157 formed therein. Yellow (Y), magenta (M), cyan (C), and black (K) ink are respectively provided to the printheads 153, through the ink channels 154. The plurality of ink channels 154 are connected to an ink feed opening 155 formed on a rear side of the nozzle unit 151, and the printhead(s) 153 is provided with ink through the ink channels 154 extending through the nozzle unit 151.

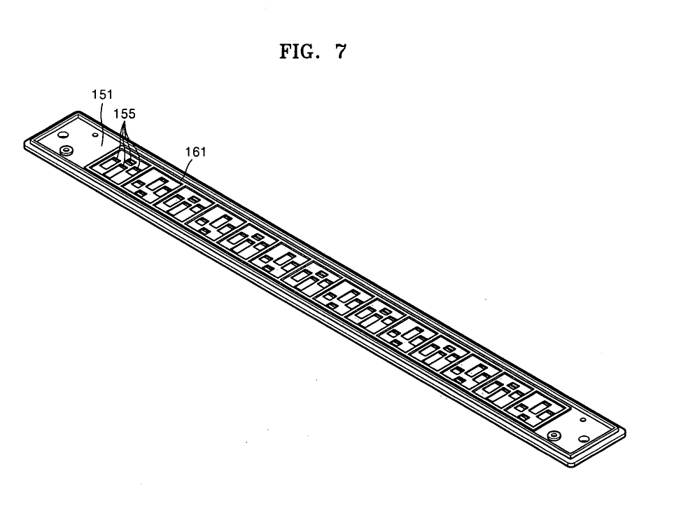

A plurality (e.g., four) of absorbing portions 162 of heat absorbing units 160 protrude through the througholes 157 in the substrate of the nozzle unit 151 by a predetermined height from each top side of the mounting grooves 152 to absorb heat generated by the printheads 153. As illustrated in FIG. 6, in order to mount the printheads 153 on the mounting grooves 152, top surfaces of the mounting grooves 152 are coated with an adhesive 156. The adhesive 156 is not coated on the ink channels 154. The absorbing portions 162 may be disposed so as not to interfere with the ink channels 154. The nozzle unit 151 may be formed of the substrate having the througholes 157 through which the absorbing portions 162 extend from a first side (i.e., the rear side) of the nozzle unit 151 having the ink feed openings 155 toward a second side (i.e., a front side) of the nozzle unit 151 having the mounting grooves 152 and the printheads 153. Accordingly, the absorbing portions 162 extend from a base 161 (see FIGS. 7 to 9) of the heat absorbing units 160 disposed at the rear side of the nozzle unit 151 to the printheads 153 through the througholes 157 in the nozzle unit 151.

In this case, the adhesive 156 may be coated to be the same height as the absorbing portions 162 such that the absorbing portions 162 are not covered with the adhesive 156.

Accordingly, when the printhead(s) 153 is mounted on the mounting groove(s) 152, the absorbing portions 162 directly contact the printhead(s) 153, and the adhesive 156 contacts remaining portions of the printhead(s) 153, where the absorbing portions 162 are not positioned.

When ink is ejected from each of the printheads 153, the printheads 153 eject different amounts of ink according to a printing pattern, thereby producing different amounts of heat. Conventionally, when some of the printheads 153 eject ink, a temperature of only the printheads 153 that eject ink is increased while temperatures of the other printheads 153 remain relatively low. Thus, the plurality of printheads 153 typically cannot maintain the temperature(s) at a constant level, and ink ejection results of each printhead 153 are different from each other. As a result, the image quality may be affected. When the heat is continuously accumulated in the printhead(s) 153, boiled bubbles can be generated and cause severe deterioration of image quality on a small portion of a printing area.

As will be described below, the heat absorbing unit(s) 160 provides a substantially uniform temperature throughout the nozzle unit 151, thereby equally distributing an increase in temperature in one or more of the printheads 153 throughout the entire nozzle unit 151 and transferring the heat away from the nozzle unit 151.

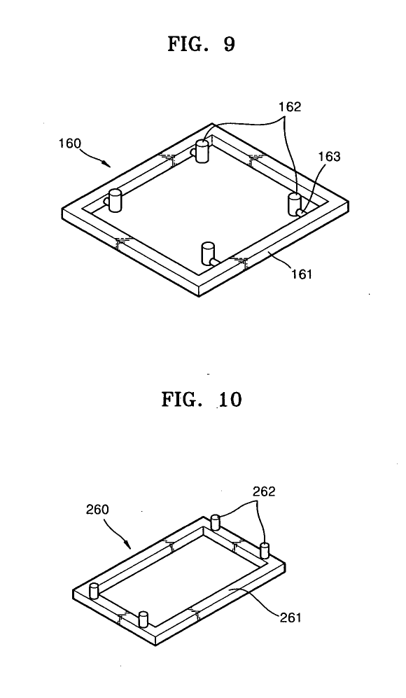

FIG. 9 is a perspective view illustrating the heat absorbing unit 160 of the nozzle unit 151. Referring to FIG. 9, the heat absorbing unit(s) 160, which absorbs the heat generated from the printhead 153(s), includes the base 161 (i.e., a rectangular base 161), the absorbing portions 162 that protrude by a predetermined height from the base 161 to directly contact the printhead(s) 153, and connection portions 163 each of which connects the absorbing portion(s) 162 to the base 161.

FIG. 10 is a perspective view illustrating a heat absorbing unit 260 of the nozzle unit 151 of FIG. 4, according to another embodiment of the present general inventive concept. While the heat absorbing unit 160 of FIG. 9 includes the connection portions 161 to connect the absorbing portions 162 to the base 161 (i.e., since the absorbing portions 162 are positioned inside the base 161), the heat absorbing unit 260 of FIG. 10 includes a base 261 of decreased size and absorbing portions 262 formed on the base 261 to protrude directly from the base 261. Accordingly, the connection portions 162 as illustrated in FIG. 9 are not necessary in the heat absorbing unit 260 of FIG. 10.

Referring to FIGS. 4 to 9, a part of the base 161 of the heat absorbing unit 160 is exposed from a bottom surface of the nozzle unit 151 and a remaining part of the base 161 is embedded in the nozzle unit 151 (see FIGS. 6, 7, and 8). An end portion of each of the absorbing portions 162 protrudes through the nozzle unit 151 to the mounting groove 152, and a remaining portion of each absorbing portion 162 is embedded in the nozzle unit 151. The heat absorbing unit(s) 160 may be formed on the nozzle unit 151 by insert injection molding.

The heat absorbing unit(s) 160 is installed on the rear side of the nozzle unit 151 to extend into each of the mounting grooves 152, and the base 161 is connected to an adjacent base 161 formed on a portion of the rear side of the nozzle unit 151 that corresponds to a neighboring mounting groove 152. Thus, the bases 161 of the heat absorbing units 160 may be connected to each other to form a single body. In other words, the nozzle unit 151 may include one or more of the heat absorbing units 160 having the plurality of bases 161 formed separately or the plurality of bases 161 formed as the single body. This single body type structure enables the heat absorbing unit 160 to equally distribute an increase in temperature of one or more of the printheads 153 throughout the entire nozzle unit 151.

The heat absorbing unit 160 is made of a metal that can absorb and conduct heat effectively, for example, aluminum or copper. In other words, the heat absorbing unit(s) 160 and 260 are made of a material that is more conductive than the printhead(s) 153, the nozzle unit 151 (i.e., the substrate of the nozzle unit 151), and the adhesive 156 such that the heat is selectively transferred by the more conductive material of the heat absorbing unit(s) 160 and 260. As a result, the heat generated by the printhead(s) 153 is transferred through a layer of the adhesive 156 and the substrate of the nozzle unit 151 to the base(s) 161 and 262 by the absorbing portions 162 and 262 and/or the connection portions 163.

The heating absorbing unit(s) 160 is connected to an external cooling unit (not shown) so that the heat produced from the printhead(s) 153 and absorbed by the absorbing portions 162 can be discharged outside of the image forming apparatus 100. Accordingly, accumulation of heat in the printhead(s) 153 can be prevented.

Since heat is directly absorbed from the printhead(s) 153 by the heat absorbing unit(s) 160 or 260 and can be equally distributed to the nozzle unit 151, a temperature difference between the printheads 153 is reduced and a constant temperature can be maintained. In this manner, the image forming apparatus 100 of the embodiments of the present general inventive concept provides good image quality. The heat absorbing unit(s) 160 and 260 may also be a heat transfer unit(s).

Additionally, since the heat absorbing unit 160 or 260 is formed inside the nozzle unit 151 by insertion injection molding, a bending strength of the nozzle unit 151 can be reinforced, thereby ensuring a standardization of product sizes.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An array inkjet head, comprising:
a nozzle unit having a length that corresponds to a width of a printing medium;
a plurality of printheads mounted in respective mounting grooves formed in the nozzle unit; and
a plurality of heat absorbing units respectively formed in the mounting grooves to directly contact the respective printheads and absorb heat generated by the printheads.

2. The array inkjet head of claim 1, wherein each of the heat absorbing units comprises:
a base; and
at least one absorbing portion that is connected to the base and protrudes through the nozzle unit to a predetermined height from a top surface of the respective mounting groove to directly contact the respective printhead disposed in the mounting groove.

3. The array inkjet head of claim 2, further comprising:
at least one connection portion respectively connecting the at least one absorbing portion to the base.

4. The array inkjet head of claim 2, wherein the bases of the respective heat absorbing units are connected to adjacent bases such that the heat absorbing units form a single body.

5. The array inkjet head of claim 2, wherein the heat absorbing units are made of aluminum or copper.

6. The array inkjet head of claim 2, wherein the heat absorbing unit units are formed on the nozzle unit by insertion injection molding.

7. An inkjet head, comprising:
a nozzle unit having at least one mounting portion disposed on a first surface thereof; and
a heat absorbing unit disposed on a second surface of the nozzle unit opposite to the first surface and having an absorbing portion extending through the nozzle unit to the mounting portion thereof.

8. The inkjet head of claim 7, further comprising:
at least one printhead disposed on the mounting portion of the nozzle unit such that the absorbing portion directly contacts the at least one printhead to transfer heat generated thereby to the second surface of the nozzle unit.

9. The inkjet head of claim 8, further comprising:
an adhesive layer formed between the at least one printhead and the first surface of the nozzle unit,
wherein the absorbing portion protrudes from the first surface of the nozzle unit to a height that corresponds to a thickness of the adhesive layer.

10. The inkjet head of claim 8, wherein:
the nozzle unit comprises at least one feed hole extending therethrough to provide ink to the at least one printhead; and
the heat absorbing unit comprises a base having a quadrangular frame shape surrounding the at least one feed hole such that the absorbing portion extends from the base through the nozzle unit to contact the at least one printhead.

11. The inkjet head of claim 7, wherein the nozzle unit comprises a plurality of ink channels extending through the mounting portion of the nozzle unit.

12. An array inkjet head, comprising:
a nozzle unit having a mounting portion;
a printhead mounted on the mounting portion;
an adhesive layer disposed on the mounting portion between the nozzle unit and the printhead to adhere the printhead to the nozzle unit; and
a heat transfer unit extending through the adhesive layer between the nozzle unit and the printhead.

13. A nozzle unit usable in an inkjet image forming apparatus, the nozzle unit comprising:
a substrate having a plurality of openings extending therethrough;
a printhead disposed on the openings in the substrate and being attached by an adhesive; and
a heat absorbing unit disposed on the substrate to contact the printhead at portions around the openings in the substrate where the adhesive is not disposed and to transfer heat away from the printhead when the heat is generated.

14. The nozzle unit of claim 13, wherein:
the printhead comprises a plurality of printheads; and
the heat absorbing unit comprises a plurality of heat absorbing units corresponding to the plurality of printheads, the heat absorbing units being integrally formed with one another such that when one or more of the plurality of printheads increases in temperature, the increase in temperature is equally distributed among the heat absorbing units.

15. The nozzle unit of claim 13, wherein the substrate has a mounting groove disposed on a first side thereof in which the printhead is mounted and at least one throughole extending through the substrate such that the heat absorbing unit is disposed on a second side of the substrate and extends through the throughole to contact the printhead.

16. The nozzle unit of claim 13, wherein:
the substrate comprises first and second sides opposite to each other with respect to a surface of the substrate, the printhead being mounted on the first side; and
the heat absorbing unit comprises a base disposed on the second side of the substrate and having at least one absorbing portion extending from the base through the substrate to contact the printhead.

17. An array type inkjet head having a plurality of printheads, the array type inkjet head comprising:
a substrate; and
a heat absorbing unit, including
a base disposed on a surface of the substrate and having a quadrangular frame shape with an opening disposed therein and extending along a plane, and
a plurality of heat absorbing portions extending from the base in a direction that is perpendicular to the plane to contact one of the printheads and to transfer heat from the one of the printheads to the base.

18. The array type inkjet head of claim 17, wherein the plurality of heat absorbing portions protrude directly from the base.

19. The array type inkjet head of claim 17, wherein the heat absorbing unit further comprises:
a plurality of connection portions extending from the base into the opening along the plane such that the corresponding heat absorbing portions extend in the perpendicular direction from the connection portions.

20. An array inkjet head, comprising:
a nozzle unit; and
a printhead disposed on a first side of the nozzle unit to form an interface therewith, the interface including
an adhesive portion to adhere the printhead to the nozzle unit,
a heat transfer portion having a heat transferring unit to transfer heat produced by the printhead to a second side of the nozzle unit opposite from the first side, and
an opening portion through which ink is provided from the second side of the nozzle unit to the printhead at the first side of the nozzle unit.

21. A heat absorbing unit usable with a nozzle unit having a plurality of printheads disposed on a first surface thereof and a plurality of througholes arranged on a second surface thereof to extend to the printheads, the heat absorbing unit comprising:
an array of frames being made of a heat conducting material; and
at least one heat absorbing portion protruding from each of the frames in a perpendicular manner such that each of the absorbing portions is coupled to one of the printheads through one of the througholes from the second surface to the first surface.

22. The heat absorbing unit of claim 21, wherein the array of frames uniformly distributes heat created by any of the printheads.

23. An inkjet image forming apparatus, comprising:
a conveying roller to convey a printing medium;
an array inkjet head including
a nozzle unit having a length that corresponds to a width of the printing medium,
a plurality of printheads mounted in respective mounting grooves formed in the nozzle unit, and
a plurality of heat absorbing units respectively formed in the mounting grooves to directly contact the respective printheads and absorb heat generated by the printheads; and
a fusing device to fuse an image onto the printing medium.

24. The inkjet image forming apparatus of claim 23, wherein each of the heat absorbing units comprises:
a base; and
at least one absorbing portion that is connected to the base and protrudes a predetermined height from a top surface of the respective mounting groove to directly contact the respective printhead.

25. The inkjet image forming apparatus of claim 24, further comprising:
at least one connection portion respectively connecting the at least one absorbing portion to the base.

26. The inkjet image forming apparatus of claim 24, wherein the bases of each of the heat absorbing units are connected to adjacent bases such that the heat absorbing units form a single body.

27. The inkjet image forming apparatus of claim 24, wherein the heat absorbing units are made of aluminum or copper.

28. The inkjet image forming apparatus of claim 24, wherein the heat absorbing units are formed on the nozzle unit by insertion injection molding.
